(19) United States
(12) Patent Application Publication
(10) Pub. No.: US 2004/0043505 A1
(43) Pub. Date: Mar. 4, 2004

(54) Collection assembly

(76) Inventors: Matthew Walenciak, Westfield, NJ (US); Lynne Rainen, Maplewood, NJ (US); Daniel Groelz, Hilden (DE); Helge Bastian, Geneve-Anieres (DE); Uwe Oelmueller, Erkath (DE)

Correspondence Address: PATTON BOGGS LLP, 8484 WESTPARK DRIVE, SUITE 900, MCLEAN, VA, 22102, US

(21) Appl. No.: 10/430,266

(22) Filed: May 7, 2003

Related U.S. Application Data
(60) Provisional application No. 60/377,986, filed on May 7, 2002.

(51) Int. Cl. G01N 1/00

(52) U.S. Cl. 436/174; 422/102

(57) ABSTRACT

The present invention is directed to a method and device for collecting and stabilizing a biological sample, particularly a whole blood sample. More specifically, the present invention relates to the use of about 5.6 to about 37.5 mM, preferably about 5.6 to about 10.1 mM, EDTA during collection of the sample and to evacuated fluid sample containers having an amount of EDTA contained therein such that, when the sample is collected, the amount achieved is about 5.6 to about 37.5 mM, preferably about 5.6 to about 10.1 mM, EDTA to stabilize the sample.

This application claims priority to U.S. Provisional Patent Application Serial No. 60/377,986, which was filed on May 7, 2002.

### FIELD OF THE INVENTION

The present invention is directed to a method and device for collecting and stabilizing a biological sample, particularly a whole blood sample, directly from a patient. More specifically, the present invention relates to the use of about 5.6 to about 37.5 mM, preferably about 5.6 to about 10.1 mM, EDTA during blood collection and to evacuated fluid sample containers having an amount of EDTA contained therein such that, when blood is collected, the amount of EDTA achieved is about 5.6 to about 37.5 mM, preferably about 5.6 to about 10.1 mM, to stabilize the blood. It is expected that the use of about 5.6 to about 37.5 mM, preferably about 5.6 to about 10.1 mM, EDTA during blood collection will also serve to preserve and enhance stabilization and/or isolation of nucleic acids, particularly deoxyribonucleic acid (DNA) and more particularly genomic DNA, and thereby inhibit ex vivo DNA degradation and/or fragmentation during storage or shipment of the blood.

### BACKGROUND OF THE INVENTION

Sample collection containers for collecting and storing blood and other body fluids or samples have been in common use for many years. Typically, collection containers are glass or plastic tubes having a resilient stopper. It is common, when using plastic tubes, to treat the tubes with various chemical agents such as silanizing agents.

Blood collection tubes are well known in the art. It is common to use anticoagulation additives, which are generally used in blood samples prior to centrifuging for the purpose of separating the various blood components. Typically, the anticoagulation additive is a buffered citrate or heparin in an aqueous solution. An example of a blood collection tube containing an anticoagulant is disclosed in U.S. Pat. No. 5,667,963 to Smith et al. The tubes can also have various stabilizing additives contained therein for preparing the blood sample for a particular blood-related test. Various anticoagulants have been used in blood collection/separation devices either alone or in conjunction with cell-sustaining solutions in order to preserve the blood sample in an uncoagulated state for a period of time prior to centrifugation and analysis. For example, some common anticoagulants include sodium heparin and sodium citrate. In particular, sodium citrate solutions have been used for many years as anticoagulants. For example, current requirements for gene amplification technologies, such as the polymerase chain reaction, recommend the use of sodium citrate for performing an anticoagulation function in whole blood. See Holodniy et al., “Inhibition of Human Immunodeficiency Virus Gene Amplification by Heparin”, J. Clin. Microbiol. 29:676-679 (1991). It is known that calcium plays a key role in the blood coagulation cascade. Sodium citrate solutions prevent the participation of calcium in blood coagulation. Typically, these sodium citrate solutions are added to freshly collected whole blood to prevent coagulation. Subsequently, calcium can be added back to the whole blood suspension to induce subsequent coagulation when desired.

The use of EDTA in blood collection is known. For example, Dawes et al., Thrombosis Research, 12(5): 851-861 (1978), describe the use of EDTA in general during blood collection and Ludlam et al., Thrombosis Research, 6(6): 543-548 (1975), disclose the use of 0.1 ml of a 10% EDTA by weight solution in 3 ml total volume (i.e., 0.33% EDTA by weight) during blood collection.

U.S. Pat. No. 4,311,482 discloses methods and apparatus for collecting blood samples using, inter alia, “standard” EDTA. Specifically disclosed is the use of 0.6 ml of a 2.5% by weight EDTA solution in a 10 ml collection tube (i.e., 0.15% EDTA by weight).

U.S. Pat. No. 5,849,517 discloses a method and composition for fixing and stabilizing tissues, cells, and cell components such that the antigenic sites and nucleic acids therein are preserved. The composition comprises, inter alia, EDTA, with a preferred concentration of up to about 0.2% by weight, and a most preferred concentration of up to about 0.1% about by weight.

U.S. Pat. No. 6,309,885 discloses the use of a reagent for lysis of blood cells in combination with at least one inhibitor of enzymes during collection of blood for detecting homocysteine and/or total folate. The patent discloses that EDTA in amounts up to about 1.1 mg/ml may be used as the inhibitor of enzymes.

The above-described amounts of EDTA during blood collection are consistent with the standards in the art. The National Clinical Chemistry Laboratory (“NCCLS”) provides standards of practice for clinical laboratories nationwide. NCCLS publication H1-A4 (NCCLS, Vol. 16, No. 13, at A3.2) discloses that the acceptable standard amount of EDTA “added to blood should be 4.55+/−8.85 μmol/ml of blood.” EDTA ratios (mg EDTA/ml of blood) specified in the NCCLS publication are: (1) disodium EDTA dehydrate (Na₂EDTA-2H₂O) 1.4 to 2.0 mg/ml; (2) dipostassium EDTA dehydrate (K₂EDTA-2H₂O) 1.5 to 2.2 mg/ml; and (3) tripotassium EDTA anhydrous (K₃EDTA) 1.5 to 2.2 mg/ml. In addition to teaching the use of the specified amounts of EDTA, the NCCLS publication discloses that excessive amounts of EDTA may cause morphological changes in blood cells.

In compliance with the acceptable EDTA wt/vol of blood ranges published in the NCCLS, conventional blood collection methods and devices generally employ between 1.4 and 2.2 mg EDTA per ml blood collected depending on the salt of EDTA used. As such, the conventional approach has been to follow the NCCLS published guidelines for preserving blood.

In recent years, there has been an increase in interest in the field of biological, medical and pharmacological science in the study of nuclei(c acids obtained from biological samples. In particular, genomic DNA (gDNA) isolated from human whole blood can provide extensive information on the genetic origin and function of cells. This information may be used in clinical practice, e.g., in predisposition testing, HLA typing, identity testing, analysis of hereditary diseases and oncology. High quality gDNA is needed for many molecular diagnostic downstream procedures (e.g., micro-array analysis, quantitative PCR, real time PCR, Southern Blot analysis, etc.). Currently available blood collection methods and devices result in the generation of micro clots after blood draw, which can lead to impure gDNA in the gDNA isolation procedure. Impure gDNA can disturb the downstream molecular analysis procedure, thereby leading to incorrect or poor results or no results at all. Measures must be taken to maintain the integrity of nucleic acids in blood, which is stored or shipped in such containers so as to allow for analysis and/or other manipulations. Therefore, there exists a need for a blood collection method and device that overcome the disadvantages of those currently used for blood collection.

### SUMMARY OF THE INVENTION

The present invention relates to the use of an anticoagulant in blood chemistry-related techniques and devices, especially blood collection and separation assemblies. More desirably, the present invention relates to a blood separation assembly including a container, preferably a blood collection tube.

The anticoagulant according to the present invention should include about 5.6 to about 37.5 mM, preferably about 5.6 to about 10.1 mM, EDTA. The inventors have discovered that a solution to the problem of maintaining the integrity of nucleic acids in blood is the addition of a surprisingly large amount of EDTA.

The EDTA can be present in a blood collection device; can be added to a blood collection device immediately prior to collection; or can be added to the blood collection device immediately after collection. Preferably, the EDTA is present in the device prior to collection.

The anticoagulant of the present invention may also be incorporated into a particular blood separation assembly, thereby providing for a new and useful version of such a device. Such devices typically include a container having an open and a closed end. The container is preferably a blood separation tube.

Another aspect of the invention is to provide a collection container for receiving and collecting a biological sample wherein the container is pre-filled with an amount of EDTA such that when the sample is collected, the molarity achieved is about 5.6 to about 37.5 mM, preferably about 5.6 to about 10.1 mM, EDTA. The pre-filled EDTA can be in solution or in a dry form. Current collection containers include glass or plastic tubes with EDTA in solution or with EDTA spray-dried to a portion of the container. A blood collection tube containing a solution of K₃EDTA in a total volume of 2 ml that, where upon an addition of 8.5 ml blood, achieves a molarity of about 8.1 mM has proven quite effective.

Another aspect of the present invention is to provide an evacuated container that is pre-filled with an amount of EDTA such that upon collection of blood a molarity of about 5.6 to about 37.5 mM, preferably about 5.6 to about 10.1 mM, EDTA is achieved, wherein the container has an internal pressure below atmospheric pressure. Preferably, the pressure is sufficient to draw a predetermined volume of blood into the container.

The present invention also addresses the need for a method and device to protect nucleic acids, and in particular DNA, during collection, transport and storage of blood. It has been found that the use of about 5.6 to about 37.5 mM, preferably about 5.6 to about 10.1 mM, EDTA would also stabilize nucleic acids, and in particular DNA, which is present in the collected sample. The concentration (wt/vol of blood) of EDTA or salts thereof employed in the present invention exceeds the amounts previously believed to be acceptable in conventional blood collection.

Another aspect of the present invention is to provide a blood collection method and device for collecting blood and mixing the blood with an amount of EDTA such that when the blood is collected, a molarity of about 5.6 to about 37.5 mM, preferably about 5.6 to about 10.1 mM, EDTA is achieved to produce a blood sample that is stable and that inhibits degradation or fragmentation of DNA such that isolation and purification of DNA in the blood sample can be conducted at a later time.

These aspects, advantages and other salient features of the present invention will become more apparent from the following detailed description of the invention, particularly when considered in conjunction with the drawings.

### BRIEF DESCRIPTION OF THE DRAWINGS

FIG. 1 is a cross sectional view of the container in one embodiment of the invention.

### DETAILED DESCRIPTION OF THE INVENTION

As used herein, the term “EDTA” indicates the EDTA portion of an EDTA compound such as, for example, K₂EDTA, K₃EDTA or Na₂EDTA.

The present invention is directed to a method and device for stabilizing and preserving a biological sample. More particularly, the present invention is directed to the use of an anticoagulant containing about 5.6 to about 37.5 mM, preferably about 5.6 to about 10.1 mM, EDTA during blood collection. In preferred embodiments of the invention, the device is a pre-filled container containing an amount of EDTA such that, upon collection of blood, a molarity of about 5.6 to about 37.5 mM, preferably about 5.6 to about 10.1 mM, EDTA is achieved.

The present invention is also directed to a method and device for stabilizing a biological sample to better maintain the structural integrity of DNA contained within that sample. More particularly, the invention is directed to a method and device for inhibiting the degradation and fragmentation of DNA in a blood sample. It is expected that about 5.6 to about 37.5 mM, preferably about 5.6 to about 10.1 mM, EDTA will inhibit, prevent, and/or reduce the occurrence of degradation and/or fragmentation of DNA in the blood sample during shipment or storage of the sample.

The biological sample can be a body fluid withdrawn from a subject. In a preferred embodiment, the biological fluid is whole blood. Examples of other biological samples include cell-containing compositions such as red blood cell concentrates, plasma, serum, urine, bone marrow aspirates, cerebral spinal fluid, tissue, cells, and other body fluids.

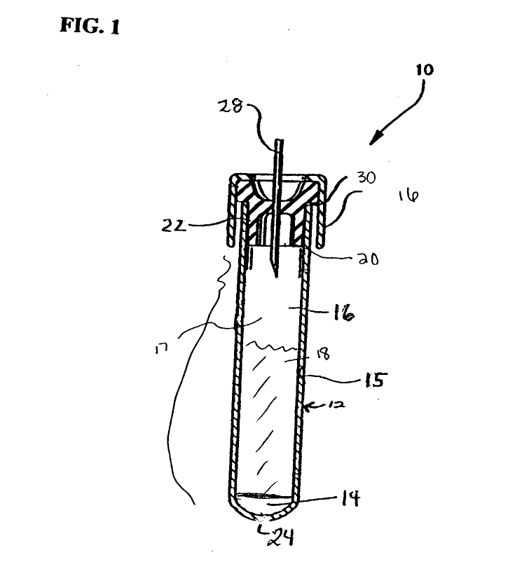

Referring to FIG. 1, the apparatus of the present invention includes a sample collection device 10, which is provided with a stoppered-container 12 and which includes about 5.6 to about 37.5 mM, preferably about 5.6 to about 10.1 mM, EDTA 14. FIG. 1 shows the EDTA in solution; however, the EDTA may also be present in solid form. Preferably, the container is a pre-filled container. Most preferably, the pre-filled container is provided with a removable capping device 16, which, when in place, serves to protect and maintain any contents of the container within the container and prevent any leakage or spillage thereof. The capping device 16 can also be configured so as to maintain a reduced internal pressure within the container relative to the pressure outside of the container.

The EDTA 14 may be pre-loaded into the container 12 of the present invention such that about 5.6 to about 37.5 mM, preferably about 5.6 to about 10.1 mM, EDTA is present when combined with the biological sample. This amount of EDTA prevents coagulation and stabilizes the biological sample, such as a blood sample, to produce a room temperature stable composition that inhibits or prevents degradation and fragmentation of DNA during storage or shipment of the biological sample. It also reduces formation of micro clots in the samples.

The collection device of the present invention can encompass any collection device including, but not limited to, tubes such as test tubes and centrifuge tubes; closed system blood collection devices, such as collection bags; syringes, especially pre-filled syringes; laboratory vessels such as flasks, vials, and other containers suitable for holding a biological sample. According to the present invention, the preferred collection device is a tube having a removable capping device capable of maintaining a lower pressure within the tube than the pressure outside of the tube.

As shown in FIG. 1, the device 10 of the present invention is for drawing a blood sample directly from a subject, preventing coagulation and stabilizing the DNA included in the blood sample by inhibiting degradation and fragmentation of the DNA. The device 10 includes a container 12 having at least one interior wall 15 that defines a reservoir 17 for containing a biological sample 18, the sample 18 in a preferred embodiment being blood. The container 12 includes at least one opening 20 that is defined by the open end 22 of the at least one interior wall 15, the opening 20 being in communication with the reservoir portion 17. A closed bottom end 24 is formed by the at least one interior wall 15. A capping device 16 is sized and configured to releasably attach to the open end 22 of the at least one interior wall 15.

It is expected that the about 5.6 to about 37.5 mM, preferably about 5.6 to about 10.1 mM, EDTA 14, which has demonstrated superior anticoagulant properties to known amounts of EDTA, inhibits, prevents and/or reduces the occurrence of degradation and/or fragmentation of DNA in the biological sample 18 during shipment or storage of the sample. The EDTA 14 stabilizes the biological sample 18 to produce a stable composition that inhibits or prevents degradation and/or fragmentation of DNA present in the biological sample. It also reduces the formation of micro clots and/or other precipitations in the sample. Preferably, the device 10 of the present invention is pre-filled with about 5.6 to about 37.5 mM, preferably about 5.6 to about 10.1 mM, EDTA 14 by the manufacturer and packaged in a ready-to-use form. Typically, the packaged collection device 10 is sterile and is packaged in sterile packaging materials.

Container 12 can be made of glass, plastic or other suitable materials. Plastic materials can be oxygen impermeable materials or contain an oxygen impermeable layer. Alternatively, container 12 can be made of water- and air-permeable plastic material. Preferably, container 12 is evacuated to an internal pressure below atmospheric pressure. The pressure is preferably selected to draw a predetermined volume of a biological sample 18 into container 12. Typically, a biological sample 18 is drawn into reservoir 17 by piercing capping device 16 with a needle 28 or cannula as known in the art. An example of a suitable container 12 and capping device 16 are disclosed in U.S. Pat. No. 5,860,397 to Cohen, which is hereby incorporated by reference in its entirety.

Container 12 is preferably made of a transparent material. Examples of suitable transparent thermoplastic materials include polycarbonates, polyethylene, polypropylene and polyethyleneterephthalate. Container 12 has a suitable dimension selected according to the required volume of the biological sample being collected. In one embodiment, container 12 has a tubular shape with an axial length of about 100 mm and a diameter of about 13 mm to about 16 mm. A preferred embodiment of the device 10 is a 100 mm×16 mm PET tube having K3EDTA with an EDTA concentration of 8.1 mM.

Capping device 16 is made of a resilient material capable of maintaining an internal pressure differential less than atmospheric and that can be pierced by a needle 28 or other cannula to introduce a biological sample 18 into container 12. Suitable materials for closure include, for example, silicone rubber, natural rubber, styrene butadiene rubber, ethylene-propylene copolymers and polychloroprene. A protective shield 30 can also be employed to releasably cover and protect the capping device 16.

In one embodiment, container 12 is made of a plastic that is water- and gas-permeable. The diffusion of oxygen through the wall of the tube has the effect of decreasing the vacuum in the container. The water and oxygen permeability properties of the container are selected to maintain the desired pressure differential within the container for the desired shelf life of the container. The shelf life is optimized by balancing the oxygen permeability with the water loss. The container has a shelf life of at least about one year, and preferably longer.

Additional additives may also be included with the EDTA 14 to help stabilize the biological sample 18. Examples of additional additives include cationic compounds, surfactants, chaotropic salts, ribonuclease inhibitors, additional chelating agents, quaternary amines, and mixtures thereof.

In addition, other components can be added to the admixture for the purpose of treating the biological sample. For example, chemical agents can be included to permeabilize or lysis cells in the biological sample 18. Other suitable components include, but are not limited to, cationic compounds, surfactants, detergents, chaotropic reagents, ribonuclease inhibitors, quaternary amines, proteinases, lipases, phenol, phenol derivatives, phenol/chloroform mixtures, alcohols, aldehydes, ketones, organic acids, simple salts like salts of organic acids, alkali metal salts of halides, additional organic chelating agents, reducing agents, buffers, sugars, fluorescent dyes, antibodies, binding agents, anticoagulants such as sodium citrate, heparin and the like, and any other reagent or combination of reagents normally used to treat biological samples for analysis.

The method of the invention is performed by obtaining a biological sample 18 and introducing the sample into the container 12, which preferably already contains the EDTA. In preferred embodiments, the biological sample 18 is prepare(t and immediately introduced directly into the collection container 12. In more preferred embodiments, the biological sample 18 is withdrawn from the patient directly into the collection container 12 without any intervening process steps. It is expected that collecting the biological sample 18 directly from the patient, such as when collecting a whole blood sample, and introducing the sample directly into the container containing about 5.6 to about 37.5 mM, preferably about 5.6 to about 10.1 mM, EDTA substantially prevents or reduces the degradation and fragmentation of the DNA that otherwise occurs when the sample is stored.

The EDTA 14 may be provided in any suitable form including, but not limited to, a solution, suspension or other liquid, a pellet, a spray-dried material, a freeze-dried material, a powder, a particle or a gel. The EDTA 14 may be located anywhere within the reservoir 17 of the container 12 and, if spray-dried into the container, can be along the at least one interior wall 15 of the collection device or anywhere within the reservoir portion. Preferably, the EDTA 14 is pre-loaded into the container 12 in liquid form.

In a preferred embodiment, the biological sample 18 is whole blood. The molarity of EDTA after mixing with the blood ranges from about 5.6 to about 37.5 mM, preferably from about 5.6 to about 10.1 mM, more preferably from about 6.3 to about 9.0 mM, and even more preferably from about 7.2 to about 8.5 mM. Most preferably, the EDTA has a molarity of about 8.1 mM. Suitable salts of EDTA that can be employed in the present invention include, for example, K₂EDTA, K₃EDTA, Na₂EDTA, Na₃EDTA, Na₄EDTA, CaNa₂EDTA, Na₂ZnEDTA, Na₂CuEDTA, Na₂MgEDTA, NaFe(III)EDTA and (NH₄)₂EDTA. Preferably, the EDTA salt is one or more of K₂EDTA, K₃EDTA and Na₂EDTA.

The present invention will be further illustrated by the following non-limiting examples.

In a series of experiments, it was investigated whether higher concentrations of EDTA in a liquid anticoagulant solution and/or higher volumes of liquid lead to a higher quality and/or higher yield of the genomic DNA.

### EXAMPLE 1

Venous whole blood was drawn from three different donors using 9 ml EDTA tubes currently available from Sarstedt (cat. no./ref. no. 02.1066.001) with a concentration of 1.6 mg EDTA per ml blood. Eight tubes of blood were drawn from each donor. 10 μl of blood from one sample of each donor was withdrawn immediately after collection to count the white blood cell number with a Neubauer chamber. Based on the assumption that one white blood cell contains approximately 6.6 pg DNA, the theoretical yield was calculated. Four blood tubes from Donors 1 to 3 were stored in the original blood collection tube without modification. The other four blood tubes from Donor 1 were mixed with 1.8 ml of a 0.9% NaCl solution (physiological salt concentration). This was achieved by transferring the blood of one tube into a 15 ml tube (conventional polypropylene round bottom centrifuge tube) containing 1.8 ml of 0.9% NaCl solution and mixing by inverting the closed tube three times. The other four tubes from Donor 2 were mixed the same way with 1.8 ml of a solution containing 0.9% NaCl and 1% Na₂EDTA. That led to a molarity of about 8.1 mM EDTA. The other four tubes from Donor 3 were mixed the same way with 1.8 ml of a solution containing 0.9% NaCl and 7.5% Na₂EDTA. That led to a molarity of about 37.5 mM EDTA.

Blood samples in the original blood collection tube and blood samples in the 15 ml polypropylene centrifuge tubes were stored three days at room temperature on the bench of the laboratory. Afterwards, the blood was stored an additional four days at 4° C.

After storage, DNA extraction was performed as follows: A blood sample was inverted 10 times to achieve a homogenous mixture of serum and red blood cells. The blood was then transferred into a 50 ml processing tube (conventional polypropylene round bottom centrifuge tubes) filled with 25 ml of a Tris/HCl buffered cell lysis solution containing Triton-X 100 and mixed by inverting the tube five times to lysis red and white blood cells. The blood was centrifuged for 5 minutes at 2000×g in a swing-out rotor to pellet cell organelles like nuclei and mitochondria. The supernatant was discarded and the tube left inverted on a piece of absorbent paper for 2 minutes. To remove protein contaminants, 5 ml of a high concentrated guanidinium-hydrochloride buffer was added and the sample vortexed until the pellet was completely homogenized.

After adding 50 μl QIAGEN-Proteinase, the sample was placed in a water bath and incubated at 65° C. for 10 minutes. After vortexing again for 10 seconds, 5 ml isopropanol was added. The tube was inverted until the white DNA strands clumped together and formed a visible precipitate. The sample was centrifuged 3 minutes at 2000×g in a swing-out rotor to pellet the DNA. The supernatant was discarded and the DNA pellet was washed by adding 5 ml 70% ethanol and vortexing 5 seconds. After another centrifugation step of 2 minutes at 2000×g, the supernatant was again discarded and the tube was left inverted on a piece of absorbent paper for 5 minutes to dry the DNA. Then, 1 ml resuspension buffer (10 mM Tris/HCl pH 8.5) was added and the sample was vortexed 5 seconds and incubated 60 minutes at 65° C. in a water bath to resolve the DNA. After the incubation, the DNA solution was transferred into a 2 ml eppendorf cap.

TABLE 1

| | EDTA | Added | | | | | |
|---|---|---|---|---|---|---|---|
| | conc. | solution | Color of | Av. yield | Av. Yield | Av. | Positive in |
| | [mg EDTA | with 0.9% | isoprop. | [μg DNA/ml | [% theo. | A260/A280 | standard |
| Donor | /ml blood] | NaCl | pellet | blood] | yield] | Ratio | PCR |
| 1 | 1.6 | No | White | 445.4 +− 33.2 | 141.5 +/− 10.6 | 1.78 +/− 0.00 | 4 of 4 |
| 1 | 1.6 | 1.8 ml | White | 404.3 +/− 16.9 | 128.4 +/− 5.4 | 1.79 +/− 0.00 | 4 of 4 |
| 2 | 1.6 | No | White | 374.4 +/− 32.5 | 120.6 +/− 10.5 | 1.79 +/− 0.01 | 4 of 4 |
| 2 | 3.6 | 1.8 ml | White | 343.0 +/− 36.7 | 110.5 +/− 11.8 | 1.79 +/− 0.01 | 4 of 4 |
| 3 | 1.6 | No | White | 56.8 +/− 5.1 | 113.5 +/− 1.3 | 1.79 +/− 0.01 | 4 of 4 |
| 3 | 16.6 | 1.8 ml | Beige | 525.4 +/− 18.1 | 130.6 +/− 4.5 | 1.77 +/− 0.00 | 4 of 4 |

Mean value and standard deviation of four samples from Donors 1-3 with or without additional solution for yield, percentage of theoretical yield and purity are shown. In addition, the color of the isopropanol DNA pellets and the performance in the standard PCR system is listed. In this PCR, a 1.1 kb fragment of the human single copy gene ‘hugl’ (homologue of giant larvae) was amplified. Table 1 indicates comparable results for all samples. Because of the small number of donors, however, there is little statistical significance in comparing the individual results.

### EXAMPLE 2

To investigate the effects of higher concentrations of liquid EDTA vs. the EDTA anticoagulants in currently available blood collection tubes, a series of evacuated tube prototypes were produced. These prototypes contained either 1.8 or 3.6 mg EDTA salt per ml blood, with different liquid volume of anticoagulant, as shown in Table 2.

TABLE 2

| | K₃EDTA conc. | | | |
|---|---|---|---|---|
| | [mg K₃EDTA/ml | | Blood draw | Tube |
| Prototype | blood] | Liquid volume | Volume | material |
| 1 | 1.8 | 2 ml | 8.5 ml | Plastic |
| 2 | 3.6 | 2 ml | 8.5 ml | Plastic |
| 3 | 1.8 | 2.5 ml | 8.0 ml | Plastic |
| 4 | 3.6 | 2.5 ml | 8.0 ml | Plastic |
| 5 | 1.8 | 3 ml | 7.5 ml | Plastic |
| 6 | 3.6 | 3 ml | 7.5 ml | Plastic |

Venous whole blood was drawn from four different donors using prototypes 1-6 (see Table 2) and a currently available spray-dried EDTA (K₂EDTA) tube from Becton, Dickinson and Company having a concentration of 1.8 mg EDTA per ml blood. From each donor was drawn one tube of each prototype 1-6 and one spray-dried tube. Blood samples were stored in a heating chamber at 40° C. in a horizontal position in the original blood collection tubes. After 48 hours, DNA extraction was performed as described in Example 1.

After 48 hours at 40° C., clotting could not be observed; however, after lysis, centrifugation and removal of the supernatant, the cell organelle pellets obtained from spray-dried EDTA blood collection tubes often had a different color and size compared to the pellets obtained from prototypes 1-6 with liquid EDTA. Cell organelle pellets from spray-dried EDTA tubes were often red to brown colored and contained a lot of smear running down on the tube wall. Cell organelle pellets from prototypes 1-6 with liquid EDTA were mostly red colored and contained less smear.

In addition, when a brown colored cell organelle pellet was dissolved with digestion buffer, the dissolved solution was brown. When a red colored cell organelle pellet was dissolved with digestion buffer, the solution appeared red or light red.

The results of the testing suggested the usefulness of the higher amounts of EDTA and led to further testing, which is described in more detail in the examples below.

### EXAMPLE 3

Venous whole blood was drawn from five different donors using prototypes 1-6. From each donor was drawn one tube of each prototype 1-6. 10 μl of blood from a 1.8 mg/ml spray-dried tube from each donor was used to determine the theoretical yield.

Blood samples were stored in an upright position in the original blood collection tubes on the bench of the laboratory for 13 days. After 13 days, DNA extraction was performed as described in Example 1.

The DNA was analysed through spectrophotometry (see Table 3).

After 13 day's storage at room temperature, clots became visible when the blood tubes were inverted prior to processing in order to get a homogenous mixture of blood and serum. By observing the flow of blood out of the tube, when the blood was transferred into a 50 ml processing tube, it was possible to distinguish between big and small clots.

After 13 day's storage at room temperature, all blood samples from the five different donors drawn into prototypes 1, 3 and 5 (with liquid anticoagulant and 1.8 mg EDTA per ml blood) contained big clots. The blood from one donor contained big clots regardless of which blood collection tube was used. The other four blood samples drawn into prototypes 2, 4 and 6 (with liquid anticoagulant and 3.6 mg EDTA per ml blood) contained less clots (see Table 3).

TABLE 3

| | | | Av. yield | | |
|---|---|---|---|---|---|
| Blood | | Color of the | [μg | Av. Yield | Av. |
| collection | | isopropanol DNA | DNA/ml | [% theo. | 260/280 |
| tube | Visible clotting | pellets | blood] | yield] | ratio |
| Prototype | big clots in all 5 | no pellet visible in | 3.1 | 9.1 +/− 9.0 | 1.89 +/− 0.14 |
| 1 | samples | all 5 samples | | | |
| Prototype | no clots in 3, | 4 times white, | 27.0 | 80.2 +/− 51.6 | 1.68 +/− 0.17 |
| 2 | small clots in 1, | 1 time white but | | | |
| | big clots in | 1 very small | | | |
| | sample | | | | |
| Prototype | big clots in all 5 | no pellet visible in | 0.8 | 2.1 +/− 0.7 | 2.61 +/− 15.0 |
| 3 | samples | all 5 samples | | | |
| Prototype | no clots in 3, | 4 times white, | 23.1 | 66.3 +/− 41.9 | 1.78 +/− 0.03 |
| 4 | small clots in 1, | 1 time white but | | | |
| | big clots in 1 | very small | | | |
| | sample | | | | |
| Prototype | big clots in all 5 | 2 times brown, | 2.2 | 7.2 +/− 10.9 | 1.61 +/− 0.70 |
| 5 | samples | 3 times no pellet | | | |
| | | visible | | | |
| Prototype | no clots in 2, | 2 times white, | 15.3 | 42.8 +/− 43.9 | 2.14 +/− 0.68 |
| 6 | small clots in 1, | 1 time white but | | | |
| | big clots in 2 | very small | | | |
| | sample | 2 times no pellet | | | |
| | | visible | | | |

For yield, percentage of theoretical yield and purity, the average value of the 5 samples from the 5 donors are shown. The standard deviation is calculated for percentage of theoretical yield and for the A260/A280 ratio. The DNA yield is shown as μg DNA per ml blood to be able to compare yield from different prototypes with different volumes of blood.

There was a clear correlation between the occurrence of clotting and the yield of genomic DNA. The more clotting in the blood, the less that the DNA could be isolated. The best yield was gained from prototype 2, with 3.6 mg EDTA per ml blood in 2 ml anticoagulant.

### EXAMPLE 4

Based on results described above, a larger study was designed. In this study, prototype 2 with 3.6 mg EDTA per ml blood in 2 ml of anticoagulant was compared to a spray-dried 1.8 mg/ml blood collection tube currently available from Becton, Dickinson and Company.

Venous whole blood was drawn from sixty (60) different donors using tubes of prototype 2 and the spray-dried EDTA tubes. From each donor, blood was drawn into two prototype and two spray-dried EDTA tubes. 10 μl of blood from one of the spray-dried tubes of each donor was used to determine the theoretical yield.

One set of each group of blood samples (i.e., 60 prototype tubes and 60 spray-dried EDTA tubes) was stored for seven days at room temperature: on the bench of the laboratory. After seven days, DNA extraction was performed as in Example 1. The other set of each group of blood samples was stored for 13/14 days at room temperature on the bench of the laboratory. After 13/14 days, DNA extraction was performed as in Example 1.

The DNA was analysed through spectrophotometry, with the results shown below in Table 4.

After seven days at room temperature, clotting was not observed in any of the tubes. After 13/14 days at room temperature, clotting was observed in only one of the prototype tubes, but in eight of the spray-dried EDTA tubes.

For purity, yield and percentage of theoretical yield, the average values of the four samples from the 60 donors are shown. The standard deviation is calculated for percentage of theoretical yield and the A260/A280 ratio. The DNA yield is shown as fig DNA per ml blood to be able to compare yield from tubes having different volumes of blood.

TABLE 4

| | Av. Yield | Av. Yield [% theo. | Av. |
|---|---|---|---|
| Blood collection tube | [μg DNA/ml blood] | yield] | 260/281 ratio |
| 7-day prototype tube | 21.98 | 52.34 | 1.81 |
| | | +/−20.99 | +/−0.09 |
| 7-day spray-dried EDTA | 24.48 | 53.65 | 1.81 |
| | | +/−17.43 | +/−0.07 |
| 13/14-day prototype tube | 23.79 | 57.53 | 1.82 |
| | | +/−34.24 | +/−0.07 |
| 13/14-day spray-dried EDTA | 20.21 | 43.38 | 1.77 |
| | +/−16.76 | +/−0.13 | |

After seven days of storage, no significant differences were seen between the prototype tubes and the currently available spray-dried tubes. After 13/14 days of storage, however, advantages could be seen including less clotting, better purity (i.e., higher A260/A280 quotient), no colored DNA solution, which indicates the presence of potential PCR inhibitors, higher average yield, etc.

### EXAMPLE 5

To compare anticoagulants, venous whole blood was drawn from four different donors using tubes of prototype 2 and a currently available tube from Becton, Dickinson and Company sold under the name “Citrat” (catalog number 366007, BD Vacutainer 10 ml, 100×16, 0.105M citrate, light blue stopper, glass tube). From each donor was drawn four prototype 2 tubes and two Citrat tubes. 10 μl of blood from the one of the Citrat tubes of each donor was used to determine the theoretical yield.

Two prototype 2 tubes from each donor were processed immediately as described in Example 1. After 21 days of storage at 25° C., the DNA extraction was performed on the remaining tubes as described in Example 1.

The DNA was analysed through spectrophotometry and the results are shown in Table 6.

TABLE 6

| Blood | | Av. yield | | |
|---|---|---|---|---|
| collection | | [μg DNA/ml | Av. yield [% theo. | |
| tube | Storage | blood] | yield] | Av. 260/280 ratio |
| Prototype 2 | T0 | 31.79 +/− 5.89 | 64.21 +/− 21.38 | 1.87 +/− 0.05 |
| Prototype 2 | 21 days at 25° C. | 26.46 +/− 5.04 | 54.09 +/− 19.20 | 1.89 +/− 0.01 |
| Citrat | 21 days at 25° C. | 2.10 +/− 0.83 | 4.47 +/− 2.52 | 1.99 +− 0.13 |

While various embodiments have been chosen to demonstrate the invention, it will be understood by those skilled in the art that various modifications and additions can be made without departing from the scope of the invention.

What is claimed is:

1. A container for collecting a biological fluid sample, the container having disposed therein an amount of an EDTA compound, wherein upon collection of the sample, a molarity of about 5.6 to about 37.5 mM EDTA is achieved.

2. The container of claim 1, wherein the sample is selected from the group consisting of whole blood, red blood cell concentrates, plasma, serum, urine, bone marrow aspirates, cerebral spinal fluid, tissue cells and other body fluids.

3. The container of claim 2, wherein the sample is whole blood.

4. The container of claim 3, wherein the molarity of the EDTA, upon collection of the blood, is about 5.6 to about 10.1 mM.

5. The container of claim 3, wherein the molarity of the EDTA, upon collection of the blood, is about 6.3 to about 9.0 mM.

6. The container of claim 4, wherein the molarity of the EDTA, upon collection of the blood, is about 7.2 to about 8.5 mM.

7. The container of claim 5, wherein the molarity of the EDTA, upon collection of the blood, is about 8.1 mM.

8. The container of claim 1, wherein the EDTA compound is present in a form selected from the group consisting of a liquid, a pellet, a spray-dried material, a freeze-dried material, a powder, a particle and a gel.

9. The container of claim 8, wherein the EDTA compound is in liquid form.

10. The container of claim 9, wherein the EDTA compound is a solution or a suspension.

11. The container of claim 8, wherein the EDTA compound is spray-dried onto an inner surface of the container.

12. The container of claim 1, wherein the EDTA compound is one or more salts of EDTA selected from the group consisting of K₂EDTA, K₃EDTA and Na₂EDTA.

13. The container of claim 1, wherein the container is selected from the group consisting of test tubes, centrifuge tubes, blood collection tubes, blood collection bags, blood separation tubes, syringes, flasks and vials.

14. The container of claim 13, wherein the container is a blood collection tube.

15. The container of claim 13, wherein the container is a blood separation tube.

16. The container of claim 15, wherein the container comprises a gel or mechanical separator, such that upon centrifugation, the gel or mechanical separator provides separation of one or more components of the blood.

17. The container of claim 3, wherein the container is evacuated to an internal pressure below atmospheric pressure.

18. The container of claim 17, wherein the internal pressure is sufficient to draw a predetermined volume of blood into the container.

19. The container of claim 1, wherein the container includes a removable capping device.

20. The container of claim 1, wherein the container is made of glass.

21. The container of claim 1, wherein the container is made of plastic.

22. The container of claim 21, wherein the container is made of a transparent material selected from the group consisting of polycarbonates, polyethylene, polypropylene and polyethyleneterephthalate.

23. The container of claim 3, wherein the container further includes one or more additives selected from the group consisting of cationic compounds, surfactants, detergents, chaotropic compounds, ribonuclease inhibitors, chelating agents, quaternary amines, proteinases, lipases, phenol, phenol/chloroform mixtures, alcohols, aldehydes, ketones, organic acids, simple salts like salts of organic acids, alkali metal salts of halides, fluorescent dyes, antibodies, binding agents, reducing agents, buffers, sugars and anticoagulants.

24. A container for collecting whole blood, the container having disposed therein an amount of an EDTA compound in liquid form, wherein upon collection of the whole blood, a molarity of about 5.6 to about 10.1 mM EDTA is achieved.

25. A container for collecting whole blood, the container having disposed therein an amount of an EDTA compound spray-dried onto an inner surface of the container, wherein upon collection of the whole blood, a molarity of about 5.6 to about 10.1 mM EDTA is achieved.

26. A blood separation tube for collecting whole blood, the tube having disposed therein a gel or mechanical separator, such that upon centrifugation the gel or mechanical separator provides separation of one or more components the blood, and an amount of an EDTA compound, wherein upon collection of the whole blood, a molarity of about 5.6 to about 10.1 mM EDTA is achieved.

27. A method for stabilizing a biological fluid sample, comprising dispersing the sample in an amount of EDTA compound, wherein upon dispersion of the biological sample, about 5.6 to about 37.5 mM EDTA is achieved.

28. The method of claim 27, wherein the sample is selected from the group consisting of whole blood, red blood cell concentrates, plasma, serum, urine, bone marrow aspirates, cerebral spinal fluid, tissue cells and other body fluids.

29. The method of claim 27, wherein the sample is whole blood.

30. The method of claim 29, wherein the molarity of the EDTA, upon dispersion of the blood, is about 5.6 to about 10.1 mM.

31. The method of claim 30, wherein the molarity of the EDTA, upon dispersion of the blood, is about 6.3 to about 9.0 mM.

32. The method of claim 31, wherein the molarity of the EDTA, upon dispersion of the blood, is about 7.2 to about 8.5 mM EDTA.

33. The method of claim 32, wherein the molarity of the EDTA, upon dispersion of the blood, is about 8.1 mM EDTA.

34. The method of claim 33, wherein the EDTA compound is one or more salts of EDTA selected from the group consisting of K₂EDTA, K₃EDTA and Na₂EDTA.

35. The method of claim 27, wherein the EDTA compound is present in a container selected from the group consisting of test tubes, centrifuge tubes, blood collection tubes, blood collection bags, blood separation tubes, syringes, flasks and vials.

36. The method of claim 35, wherein the container is a blood collection tube.

37. The method of claim 36, wherein the container is a blood separation tube.

38. The method of claim 36, wherein the container is made of glass.

39. The method of claim 36, wherein the container is made of plastic.

40. The method of claim 39, wherein the container is made of a transparent material selected from the group consisting of polycarbonates, polyethylene, polypropylene and polyethyleneterephthalate.

41. The method of claim 29, wherein the container further includes one or more additives selected from the group consisting of cationic compounds, surfactants, detergents, chaotropic compounds, ribonuclease inhibitors, chelating agents, quaternary amines, proteinases, lipases, phenol, phenol/chloroform mixtures, alcohols, aldehydes, ketones, organic acids, simple salts like salts of organic acids, alkali metal salts of halides, fluorescent dyes, antibodies, binding agents, reducing agents, buffers, sugars and anticoagulants.

42. The method of claim 29, wherein the container is evacuated to an internal pressure below atmospheric pressure.

43. The method of claim 42, wherein the internal pressure is sufficient to draw a predetermined volume of blood into the container.

44. The method of claim 43, wherein the dispersing comprises directing blood from a patient into the container.

45. A process for extracting DNA from a blood sample, comprising the steps of:
providing a blood collection container comprising blood and an amount of an EDTA compound, wherein the amount of EDTA is about 5.6 to about 37.5 mM; and
performing a DNA extraction procedure on the blood sample.

46. The method of claim 45, wherein the sample is selected from the group consisting of whole blood and red blood cell concentrates.

47. The method of claim 45, wherein the sample is whole blood.

48. The method of claim 47, wherein the molarity of the EDTA, upon collection of the blood, is about 5.6 to about 10.1 mM.

49. The method of claim 48, wherein the molarity of the EDTA, upon dispersion of the blood, is about 6.3 to about 9.0 mM.

50. The method of claim 49, wherein the molarity of the EDTA, upon dispersion of the blood, is about 7.2 to about 8.5 mM EDTA.

51. The method of claim 50, wherein the molarity of the EDTA, upon dispersion of the blood, is about 8.1 mM EDTA.

52. The method of claim 51, wherein the EDTA compound is one or more salts of EDTA selected from the group consisting of K₂EDTA, K₃EDTA and Na₂EDTA.

53. The method of claim 45, wherein the EDTA compound is present in a container selected from the group consisting of test tubes, centrifuge tubes, blood collection tubes, blood collection bags, blood separation tubes, syringes, flasks and vials.

54. The method of claim 53, wherein the container is a blood collection tube.

55. The method of claim 54, wherein the container is a blood separation tube.

56. The method of claim 54, wherein the container is made of glass.

57. The method of claim 54, wherein the container is made of plastic.

58. The method of claim 57, wherein the container is made of a transparent material selected from the group consisting of polycarbonates, polyethylene, polypropylene and polyethyleneterephthalate.

59. The method of claim 47, wherein the container further includes one or more additives selected from the group consisting of cationic compounds, surfactants, chaotropic salts, ribonuclease inhibitors, chelating agents, quaternary amines, proteinases, phenol, phenol/chloroform mixtures, alcohols, aldehydes, ketones, organic acids, salts of organic acids, alkali metal salts of halides, fluorescent dyes, antibodies, binding agents and anticoagulants.

60. The method of claim 47, wherein the container is evacuated to an internal pressure below atmospheric pressure.

61. The method of claim 60, wherein the internal pressure is sufficient to draw a predetermined volume of blood into the container.
